(19) United States
(12) Patent Application Publication
(10) Pub. No.: US 2002/0052851 A1
(43) Pub. Date: May 2, 2002

(54) System for creating a secure, on-line exchange of medical images

(76) Inventor: Phillip M. Berman, Coronado, CA (US)

Correspondence Address: Thomas H. Close, Patent Legal Staff, Eastman Kodak Company, 343 State Street, Rochester, NY, 14650-2201, US

(21) Appl. No.: 09/860,732

(22) Filed: May 18, 2001

Related U.S. Application Data
(60) Provisional application No. 60/206,587, filed on May 23, 2000.

(51) Int. Cl. G06F 17/60

(52) U.S. Cl. 705/64; 705/3

(57) ABSTRACT

A system for creating a secure exchange of medical images over a network comprising: a plurality of remote servers or storage devices for storing medical image files; a central server connectable to said plurality of remote servers or storage devices over a network, said central server storing a centralized index or registry of medical image files located at said plurality of remote servers or storage devices, said medical image files being indexed by server identification, and medical image file identification including patient identification (patient name, patient social security number, patient date of birth), date of imaging study, subject of image, local file or medical record identifier; a user interface connectable to said network; and software resident in said central server for managing in a secure environment access to said centralized index from said user interface and secure transfer of medical image files over said network from said remote servers to said user interface.

### CROSS REFERENCE TO RELATED APPLICATIONS

This is a 111A application of Provisional Application Ser. No. 60/206,587, filed on May 23, 2000.

### FIELD OF THE INVENTION

This invention relates in general to a medical imaging system and more particularly to a system for creating a secure on-line exchange of medical images.

### BACKGROUND OF THE INVENTION

Napster has created a software application that allows users to download music files from any Napster-enabled server connected to the Internet. Napster maintains a centralized index or registry of available music and file locations. Once a music file has been chosen, the software connects the user to a remote server and facilitates the download process. This method allows Napster to leverage the storage capacity of remote servers, without actually having to mirror the files on its own servers.

It is also known in the prior art for certain medical image servers to provide links to each other, so long as there is an established, trusted relationship. For instance, Hospital A and Hospital B have a long standing relationship and the Doctors from both facilities often work with one another. These hospitals might link their image servers together so that images could be transferred from facility to facility.

Secured transaction processing, including the use of digital certificates, encryption, and authentication, is also known in the art. Many on-line companies extensively use these systems.

There is thus a need for finding a solution to these problems.

### SUMMARY OF THE INVENTION

According to the present invention, there is provided a solution to these problems.

According to a feature of the present invention, there is provided a system for creating a secure exchange of medical images over a network comprising: a plurality of remote servers or storage devices for storing medical image files; a central server connectable to said plurality of remote servers or storage devices over a network, said central server storing a centralized index or registry of medical image files located at said plurality of remote servers or storage devices, said medical image files being indexed by server identification, and medical image file identification including patient identification (patient name, patient social security number, patient date of birth), date of imaging study, subject of image, local file or medical record identifier; a user interface connectable to said network; and software resident in said central server for managing in a secure environment access to said centralized index from said user interface and secure transfer of medical image files over said network from said remote servers to said user interface.

### ADVANTAGEOUS EFFECT OF THE INVENTION

The invention has the following advantages.

1. Medical image files are transferred and accessed in a secure environment.

2. Medical image files need not be stored at a central location, reducing cost and system complexity.

### BRIEF DESCRIPTION OF THE DRAWINGS

FIG. 1 is a diagrammatic view of an embodiment of the present invention.

### DETAILED DESCRIPTION OF THE INVENTION

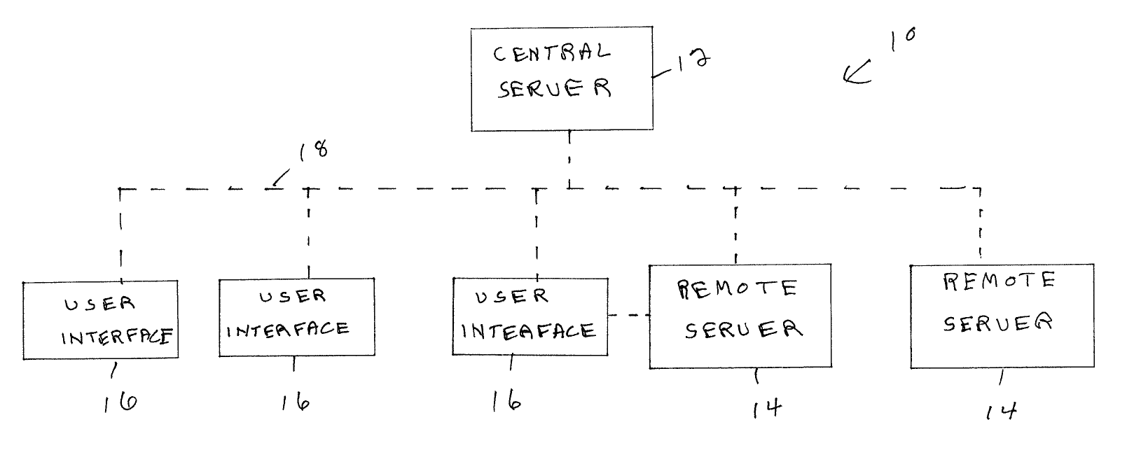

This invention proposes to create a trusted, secure relationship among diverse medical image servers to enable the on-line retrieval of medical images. As shown in FIG. 1, the system 10 of the invention includes a central server 12, remote servers 14, and user interfaces 16 all connected over a network 18, such as the Internet. User interface 16 can also be located at a remote server 14.

A central server 12 retain a centralized index or registry of medical image files located on any remote server 14 and/or associated imaging devices. Images might be indexed by server identification, patient Social Security number, date of birth, date of imaging study, subject of image and local file or medical record identifier. The index would be constantly updated to reflect changes and to ensure that the file paths are still accurate. Image files would not be retained at the central server. A user would logon at user interface 16 to the central server 12 and select images for download from remote servers. The software on the central server 12 would manage the entire transaction, and multiple layers of security would govern the process.

Various authentication and digital certificate schemas would control the interaction among the central server 12, users 16 and remote image servers 14. Only approved and authenticated users and image servers would have access to the central server. Digital certificates and encryption would also regulate image retrieval from the remote servers.

For example, Hospital A in St. Louis has never worked with Hospital B in Palo Alto, yet there is a need to transfer medical images from one to the other. Using this invention, a doctor at Hospital B could logon to the central server, locate the desired images, and download then from Hospital A, with the entire transaction taking place in a secure environment.

The invention has been described in detail with particular reference to certain preferred embodiments thereof, but it will be understood that variations and modifications can be effected within the spirit and scope of the invention.

### Parts List

| | |
|---|---|
| 10 | system |
| 12 | central server |
| 14 | remote server |
| 16 | user interface |
| 18 | network |

What is claimed is:

1. A system for creating a secure exchange of medical images over a network comprising:
a plurality of remote servers or storage devices for storing medical image files;
a central server connectable to said plurality of remote servers or storage devices over a network, said central server storing a centralized index or registry of medical image files located at said plurality of remote servers or storage devices, said medical image files being indexed by server identification, and medical image file identification including patient identification (patient name, patient social security number, patient date of birth), date of imaging study, subject of image, local file or medical record identifier;
a user interface connectable to said network; and
software resident in said central server for managing in a secure environment access to said centralized index from said user interface and secure transfer of medical image files over said network from said remote servers to said user interface.

2. The system of claim 1 wherein said medical image files are transferred using one or more of digital authentication, digital encryption, and digital certificate protocols to ensure secure file transfer.

3. The system of claim 1 wherein said user interface can be located at one of said plurality of remote servers or storage devices.
